(19) United States
(12) Patent Application Publication
(10) Pub. No.: US 2012/0093524 A1
(43) Pub. Date: Apr. 19, 2012

(54) METHOD FOR PRINTING AN IMAGE ONTO A SHEET IN A PRINTER

(76) Inventors: Rolf Spilz, Gettorf (DE); Jorg Leyser, Kiel (DE); Volker Otto, Gettorf (DE); Matthias Wecker, Bebra-Asmushausen (DE); Dieter Dobberstein, Melsdorf (DE); Stefan Schluenss, Schacht-Audorf (DE); Heiko Hunold, Wattenbeck (DE); Thomas Jacobsen, Kiel (DE); Karlheinz Peter, Molfsee (DE)

(21) Appl. No.: 12/810,357

(22) PCT Filed: Dec. 24, 2007
(86) PCT No.: PCT/EP07/11422

§ 371 Date: Sep. 27, 2010

(51) Int. Cl. G03G 15/00

(52) U.S. Cl. 399/16

(57) ABSTRACT

A method of printing an image onto a sheet in a printer having at least one print module and a transport arrangement defining a transport path for transporting sheets through the at least one print module is shown. In accordance with the method, a series of constant frame clock signals is generated and a sheet is approximately feed into a frame along the sheet transport path in accordance with the frame clock signal, wherein the frame defines a virtual desired sheet position, which moves with a predetermined speed along the sheet transport path. The sheet is transported along the sheet transport path, an in-track position of the sheet in the sheet transport path is detected and it is determined whether the in-track sheet position matches the frame within predetermined limits. If the sheet matches the frame within predetermined limits, a start of frame signal is issued at a predetermined fixed time following the generation of the frame clock signal in accordance with which the sheet was fed into the frame, wherein the start of frame signal starts generation of a latent toner image in the print module for transfer to the sheet. If the sheet does not match the frame position within predetermined limits, the start of frame signal is issued at a specified time following the generation of the frame clock signal in accordance with which the sheet was fed into the frame, wherein the specified time corresponds to the predetermined fixed time to which a time shift is added, wherein the time shift is determined on the basis of the deviation of the actual sheet. Finally, the sheet is aligned in-track in accordance with the start of frame signal, and the thus aligned sheet is transported through the print module in alignment with the latent toner image to transfer the same to the sheet.

### FIELD OF THE INVENTION

The present invention generally relates to a method of printing an image onto a sheet in a printer having at least one print module and a transport arrangement defining a transport path for transporting sheets through the at least one print module.

### BACKGROUND OF THE INVENTION

In the field of electro-photographic printing it is known to have a printing apparatus having at least one print module and a transport arrangement defining a transport path for transporting sheets throughout the printing apparatus. The transport arrangement typically has a plurality of separate transport units, which interact to transport the sheet throughout the printing apparatus. One of these units is typically designated for transporting sheets through the at least one print module. This designated unit is typically operated with a constant speed which is synchronized with the printing speed of the print module. Such synchronization may for example be achieved by frictionally driving a photoconductor drum of the print module by a transport belt of the transport unit. Another transport unit is typically formed by an aligner, which while transporting a sheet along the transport path provides alignment of the sheet with respect to the print module.

For proper registration of an image on a sheet it is necessary that the sheet is properly aligned to a latent toner image generated in the print module. It has to be aligned, with respect to skew, a cross-track position and an in-track position.

Skew and cross-track alignment are typically unproblematic, because sheets can be deskewed aligned with respect to the cross-track position independent of the status of the print process within the print module. In-track alignment, however, necessitates specific timing of generating a latent toner image in the print module and transporting of the sheet into the print module.

In order to achieve such proper timing, different approaches have been taken in the past. In one method, which is called image-follows-paper, a sheet is transferred by the aligner in an aligned manner (with respect to skew and cross-track positioning) to the designated transport unit for transporting the sheet through the print module. Once the sheet transferred thereto, the lead edge of the sheet is detected at a certain position, which then triggers issuance of a start of frame signal which sets of generation of a latent toner image in the print module. The generation of the latent toner image typically includes generating a latent charge image on a rotating photoconductor drum, and transferring toner to the photoconductor drum in accordance with the latent charge image, to thereby generate a latent toner image on the rotating photoconductor drum. This latent toner image may then be transferred to a rotating transfer roller, which finally transfers the latent toner image in a transfer nip onto a sheet, which is transported through the print module by the designated transport unit. From the above it is clear, that the point of detection of the lead edge of the sheet has to be spaced from the transfer nip by at least the distance extending from the transfer nip around the transfer roller and the photoconductor drum to a writing device for generating the latent charge image on the photoconductor drum. This leads to a long transport unit for transporting a sheet through the print module, inasmuch as the lead edge has to be detected while already being on this transport unit in order to avoid any misalignment in the in-track direction to occur. The transport unit thus has to have an extension downstream of the transfer nip which is larger than the distance around the photoconductor drum and the transfer roller from the point of generating the latent charge image to the transfer nip.

Another concept of achieving proper in-track alignment of a sheet with respect to a latent toner image is a method which is called paper-follows-image. In this method the start of frame signal is issued at fixed point in time prior to the sheet to be printed being transferred to the transport unit for transporting the sheet through the print module. The generation of the latent toner image is thus started independent of the position of the sheet to be printed. The sheet then has to be transferred with a specific timing to the transport unit which transports the sheet through the print module. In order to achieve this, the aligner may have slow-down and speed-up capabilities for advancing delaying transferring the sheet to the transport device in accordance with the specific timing. In this approach, it is, however, necessary that the sheet always arrives at the aligner within a certain time frame, which allows the aligner to transfer the sheet with the specific timing to the transport unit for transporting the sheet through the print module. These time frames may be rather short, depending on the speed up/slow down capabilities of the aligner and the inter-frame distances used, i.e. the distances set for subsequent sheets in the transport path. In order to achieve delivery of the sheets within the specific time frames, high accuracy of those sections of the transport arrangement which are arranged downstream of the aligner are necessary, which leads to an expensive set-up especially if the transport path extends over several sheet length, which is typically the case when a duplex path is provided.

It is therefore an object of the present invention to overcome one or more of the disadvantages of the prior art.

In accordance with the present invention, a method for printing an image onto a sheet in accordance with claim 1 is provided.

The method in particular provides printing an image onto a sheet in a printer having at least one print module and a transport arrangement defining a transport path for transporting sheets through the at least one print module. In the method a frame clock signal generator is operated for generating a constant series of frame clock signals, feeding of a sheet approximately into a frame position along the sheet transport path in accordance with the frame clock signal, wherein the frame position corresponds to a desired sheet position along the sheet transport path. The sheet is then transported along the sheet transport path and the actual position of the sheet in the sheet transport path with respect to the frame position is determined and it is checked whether the actual sheet position meets the frame position within predetermined limit. If the sheet meets the frame position within predetermined limit, a start of frame signal is generated after a predetermined number of the frame clock signals following the feeding of the sheet into the frame position, wherein the start of frame signal sets a fixed time for starting generation of a latent toner image in the print module for transfer to the sheet, and the sheet is then aligned in accordance with the start of frame signal, to align the sheet to the latent toner image generated in the print module. The above method, thus, provides a combination of a image follows paper and paper follows image methods described above, inasmuch as starting generation of the latent toner image occurs a fixed time after feeding the sheet into a frame position along the sheet transport path, which time is defined by the predetermined number of frame clock signals and the start of frame signal. At the same time, fine alignment of the sheet to the latent toner image is performed in accordance with the start of frame signal. This method, thus, allows use of a shorter designated transport apparatus for transporting the sheet through the print module.

The foregoing and other objects, features and advantages of the invention will be apparent from the following more detailed description of exemplary embodiments of the method described in accordance with an exemplary printing apparatus, as illustrated in the accompanying drawings.

### BRIEF DESCRIPTION OF THE DRAWINGS

FIG. 1 is a schematic side view of an electro-photographic printing apparatus;

FIG. 2 is an enlarged schematic side view of a part of the electro-photographic printing apparatus of FIG. 1;

FIG. 3 is a flow diagram of a method of operating the electro-photographic printing apparatus of FIG. 1.

### DESCRIPTION OF PREFERRED EMBODIMENTS

The following description may use relative terms such as left right above and below, which relative terms refer to the drawings and should not be construed to limit the application.

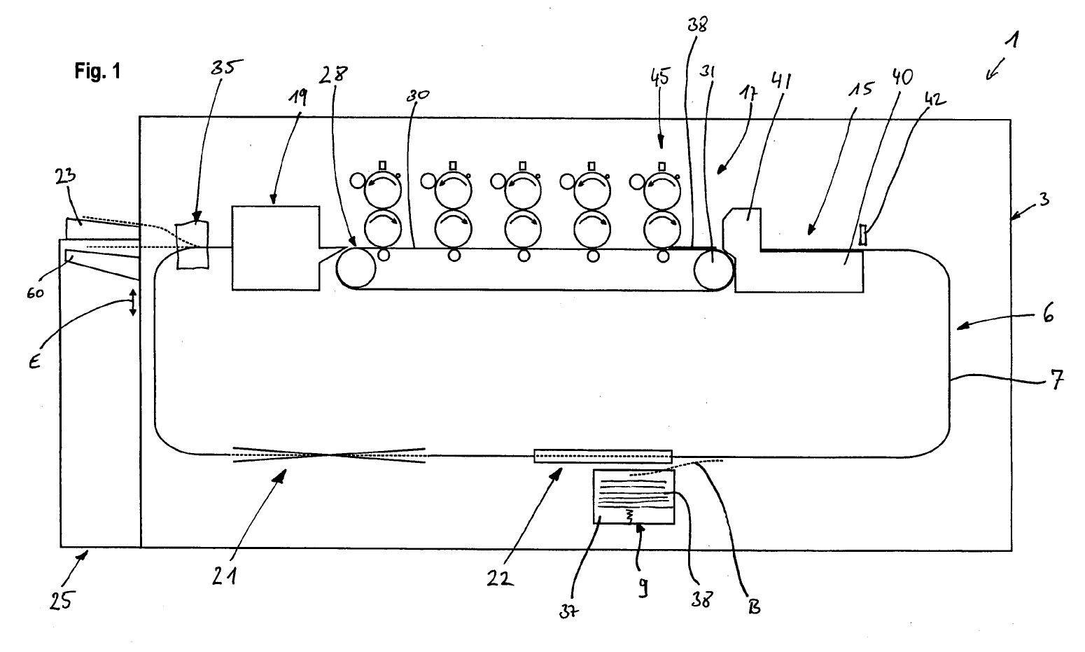

FIG. 1 shows a schematic side view of an electro-photographic printing apparatus 1. The printing apparatus 1 has a housing 3 for mounting different elements therein or thereon, as will be described in more detail herein below. Within the housing 3, a transport arrangement 6 defining a closed loop transport path 7 is provided. The following are arranged within the housing 3 along the transport path 7: a sheet supply 9, a sheet-aligner 15, a print unit 17, a fuser 19, an inverter 21 and a speed-up/delay unit 22.

External to the housing a proofing tray 23 and a sheet output 25 are provided. Even though these elements are shown outside of the housing 3, they may also be integrated within the housing 3.

The transport arrangement 6 may be of any suitable type for transporting a sheet along the transport path 7 through the printing apparatus 1. The transport arrangement 6 is formed by a plurality of transport units, with each unit forming a section of the transport path 7. At least one transport unit (not shown) is provided for transporting sheets along a section of the transport path 7 extending from the sheet supply 9 to the aligner 15. The aligner 15 forms another transport unit (as will be described in more detail herein below), forming a first alignment section of the transport path 7. Downstream of the aligner 15, a transport unit 28 is provided, which is a designated transport unit for transporting sheets through the print unit 17. The transport unit 28 as shown is formed by a belt 30, which is entrained about two rollers 31, at least one of which is driven by an appropriate drive mechanism (not shown). The belt 30 is preferably an electrostatic type belt or a suction type belt, which enables securely holding a sheet in a fixed relation to the belt, while transporting the same through the print unit 17. Downstream of the transport unit 28, the fuser 19 has an internal transport unit, forming another section of the transport path. At least one transport unit (not shown) is provided for transporting sheets along another section of the transport path 7 extending from the fuser 19 to inverter 21, which also forms a transport unit. An further transport unit (not shown) is arranged downstream of the inverter 21 for transporting sheets from the inverter 21 to the speed-up/delay unit 22, which forms the last transport unit for defining the transport path 7. The speed-up/delay unit 22 forms a second alignment section of the transport path 7. Downstream of the speed-up/delay unit 22, the at least one transport unit for transporting sheets along the section of the transport path 7 extending from the sheet supply 9 to the aligner 15 is arranged. The respective transport units are driven by respective drives and controlled by a controller, for synchronization of a sheet transport throughout the printing apparatus 1. Sheets, which are fed from the sheet supply 9 into the transport path 7 are transported by the individual transport units throughout the printing apparatus 1 along a direction of transport as indicated by arrow A. This direction of transport is also called the “in-track” direction.

Downstream of the fuser 19, a guide unit 35 is provided, for selectively guiding a sheet towards the proofing tray 23, the sheet output 25 or further along the transport path 7. The section of the transport path 7 extending between sheet supply 9 to the guide unit 35 may be called a simplex path, while the section extending between guide unit 35 and sheet supply 9 may be called a duplex path, in which sheets which have an image printed on a first side thereof are cycled back to the simplex path while being inverted, to allow printing on the reverse side, as is known in the art.

The sheet supply 9 has a storage compartment 37 for storing a stack of sheets 38 and a feeder (not shown) for feeding individual sheets 38 into the transport path 7, as indicated by the dashed line B. The sheet supply 9 can be of any suitable design for feeding individual sheets 38 into the transport path 7. Even though, FIG. 1 only shows a single sheet supply 9, several sheet supplies, which may for example hold different types of sheets may be provided. These sheet supplies may be arranged in a manner that the sheets are in substance fed at the same position into the transport path 7. Feeding of sheets into the transport path is timed with a frame clock signal, as will be explained in more detail hereinbelow.

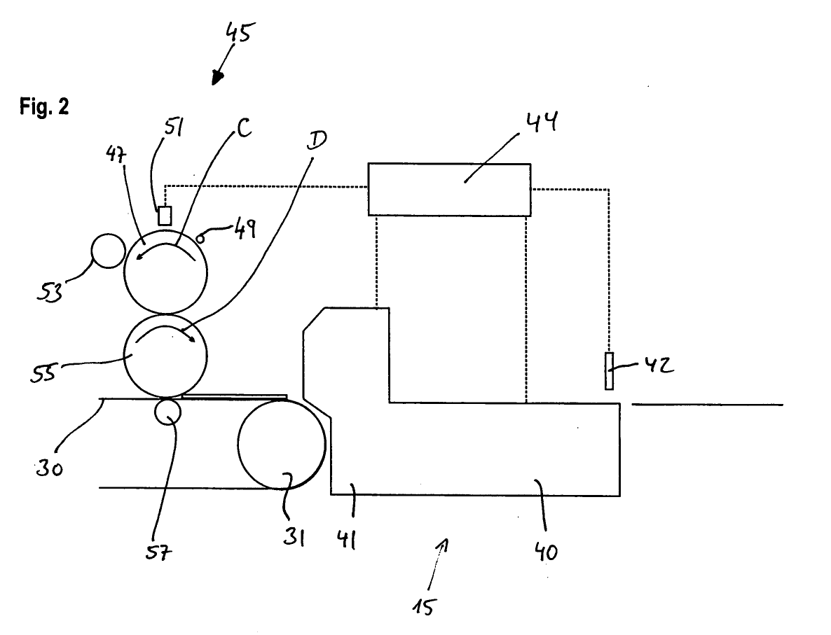

The sheet aligner 15 is arranged downstream of the position where sheets 38 are feed into the transport path by the sheet supply 9. The distance along the transport path 7 extending from the position at which the sheet supply 9 feeds sheets 38 to the aligner 15 is larger than several lengths of the sheets 38. The sheet aligner 15 may be of any suitable type for aligning sheets 38 in the transport path with respect to an in-track position, i.e. in the direction of transport A and preferably also with respect to skew and with respect to a cross-track position, i.e. at right angle to the direction of transport A. The sheet aligner 15 as shown has a pre-alignment section 40 and a final alignment section 41, as is known in the art. The pre-alignment section 40 and the final alignment section 41 are capable of providing a predetermined maximum amount of adjustment with respect to the in-track position of a sheet, which amount is limited by the maximum acceleration/deceleration of a sheet transport mechanism while the sheet is within the aligner and is also influenced by the length of the aligner. The amount may also be influenced by skew and cross-track misalignment of the sheet which may also be corrected in the aligner. Also the inter frame distances may limit the maximum amount the aligner may adjust the position of the sheet in the in-track direction. The maximum amount of adjustment may thus be calculated on for each sheet entering the aligner or may be fixed for a specific aligner. The pre-alignment section 40 has at least one lead edge sensor 42 for sensing a lead edge of a sheet entering the pre-alignment section 40. As shown in FIG. 1, the lead edge sensor 42 is located at the downstream end of the pre-alignment section 40. The lead edge sensor 42 is connected to a controller 44, as shown in FIG. 2, which controller 44 controls several aspects of a printing operation, as will be explained in more detail hereinbelow. The lead edge sensor may have two sensors which are spaced a predetermined distance in the cross-track direction, to determine skewing of a sheet upon entering the pre-alignment section.

The print unit 17 is arranged downstream of the sheet aligner 15 and has one or more electro-photographic print modules 45. The printing apparatus 1 as shown in FIG. 1 has five electro-photographic print modules 45 for the application of toner onto a sheet 38. Depending on the printing apparatus 1, a lower or higher number of printing modules 45 may be provided.

The five print modules 45, one of which is shown enlarged in FIG. 2, each have a photoconductor drum 47, a charge device 49, a selective discharge device 51, a toner application device 53, a transfer roller 55 and a back-up roller 57.

The photoconductor drum 47 may be of a known type having a photoconducting surface. The photoconductor drum 47 may be coupled to a drive mechanism (not shown), for rotating the drum in the direction of arrow C. Preferably, however, the photoconductor drum 47 is mounted to be freely rotatable about a centered axis of rotation, and rotation of the photoconductor drum 47 is achieved by movement of belt 30, which is frictionally coupled to the photoconductor drum 47 via transfer roller 55.

The charging device 49 may be any suitable device for homogenously charging the outer surface of the photoconductor drum 47, such as a corona discharge device. The selective discharging device 51 is arranged downstream of the charging device 49 in the direction of rotation C of the photoconductor drum 47. The selective discharge device 51 may be a device capable of selectively directing light onto the charged surface of the photoconductor drum 47, to thereby selectively locally discharge the surface of the photoconductor drum 47. In so doing, a latent charge image may be formed on the surface of the photoconductor drum 47. A typical device used for this purpose is an LED arrangement having a plurality of light emitting diodes arranged in series across the entire width of the photoconductor drum. Each diode addresses one print dot and the spacing between the LED's corresponds to the resolution desired for the printed image.

The toner application device 53 may be of any suitable design applying a toner to the photoconductor drum 47 in accordance with the latent charge image. It may be of the type having a magnet roller in contact with toner particles and a jump roller. Suitable toner application devices are described e.g. in U.S. Pat. No. 4,546,060 and US 20060177240.

The transfer roller 55 is arranged below the photoconductor drum 47 and in contact therewith, such that a transfer nip is formed therebetween. The transfer roller 55 preferably has an elastic surface to ensure proper contact across the transfer nip between the photoconductor drum 47 and the transfer roller 55. Transfer roller 55 is mounted to be freely rotatable about a centered axis of rotation. During operation of the print module 45, transfer roller 55 is rotated in the direction of arrow D by movement of belt 30, which is frictionally coupled thereto. The back-up roller 57 is arranged below the transfer roller 55 and forms another transfer nip therewith, through which the transport belt 30 and a sheet 38 may pass. The back-up roller 57 ensures that the belt 30 or a sheet 38 (if present) is pressed against the transfer roller 57 while being moved through the transfer nip.

The above is only one example of a structure of the print module 45, and the skilled person will easily recognize other structures which may be used in combination with the inventive method described hereinbelow.

Downstream of the print unit 17 a fuser 19 is provided. The fuser 19 may be of any suitable type for fusing toner applied by the print modules 45 to a sheet 38, while transporting the sheet along the transport path. The fuser 19 may be of a contact type using for example fusing rollers and/or a fuser belt, or of a non-contact type using for example UV-radiation or microwaves for fusing a toner to a sheet. The type of fuser 19 is at least partially dependent on the toner used in the print module 45. The guide 35, which is arranged downstream of fuser 19, may be of any suitable design for selectively guiding a sheet 38 towards the proofing tray 23, the sheet output 25 or further along the transport path 7.

Inverter 21 is arranged downstream of the guide 35 along the transport path 7 and upstream of the sheet supply 9. The sheet inverter 21 is of any suitable type for inverting a sheet in the transport path, to allow duplex printing of a sheet 38. Inverter 21 is preferably of a type, in which the sheet is inverted in such a manner, that the leading edge of the sheet is not changed during the inversion process. The speed-up/delay unit 22 may be any suitable transport unit, which provides for locally speeding up/delaying transport of a sheet 38 therethrough in such a manner that at the inlet and outlet ends of the unit, the speed of the sheet is synchronized in substance to the speed of transport of adjacent transport units. The speed-up/delay unit 22 is arranged at the end of the duplex path for feeding sheets 38 which are in the duplex path back into the simplex path. Feeding of sheets by the speed-up/delay unit 22 into the simplex path is also timed with a frame clock signal, as will be explained in more detail hereinbelow.

The proofing tray 23 may be any suitable tray for receiving sheets 32 thereon for proofing purposes, as known in the art. The sheet output 25 may again be of any suitable design for receiving printed sheets 32. As shown in FIG. 1, the sheet output 25 has a tray 60, which may be moved up and down, as indicated by double-headed arrow E, depending on the number of sheets stacked thereon.

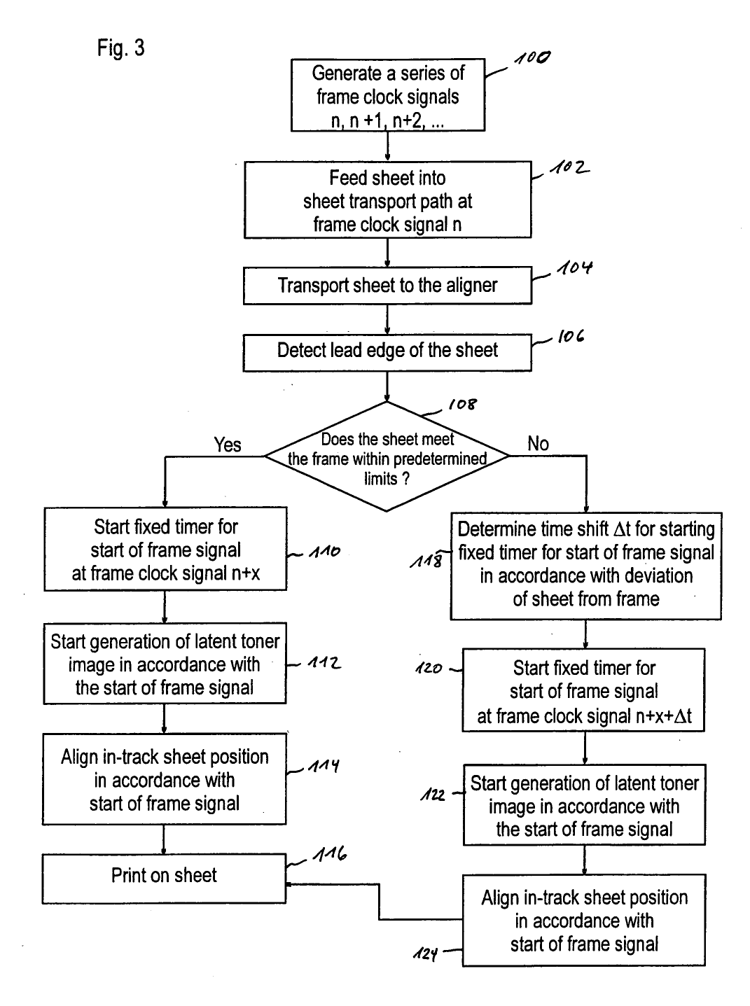

Operation of the printing apparatus 1 will be described hereinbelow with respect to FIGS. 1 to 3 and in particular with respect to the flow diagram shown in FIG. 3.

As indicated by block 100 in FIG. 3, a series of constant frame clock signals n. n+1, n+2 . . . is generated. This series of frame clock signals may for example be generated by a frame signal generator which may be incorporated into the control unit 44 shown in FIG. 2 or which may be a separate element. The frame clock signals are evenly spaced and each signal defines the beginning and/or the end of a frame at a certain position along the sheet transport path 7. A frame virtually defines a desired sheet position along the sheet transport path 7. The position of a frame is not stationary, but virtually moves with a predetermined speed along the sheet transport path 7.

A virtual print queue will be formed, for example by the controller 44 shown in FIG. 2, in which images to be printed are assigned to frames in accordance with the frame clock signals. The images to be printed will be assigned to a corresponding frame prior to feeding of a sheet into the frame.

As shown in block 102 of FIG. 3, individual sheets will be fed into the sheet transport path, in accordance with the series of frame clock signals. Block 102 specifically shows the example of feeding a sheet into the sheet transport path at frame clock signal n. Feeding of the sheet into the sheet transport path 7 occurs at the beginning of the simplex path described above with respect to FIG. 1, either via sheet supply 9 or the speed up/delay unit 22. By feeding the sheet in accordance with the series of frame clock signals, the sheet is approximately positioned into the virtual position of a frame along the transport path. The sheet is then transported by the respective transport unit along the sheet transport path 7 towards aligner 15, in accordance with block 104. The respective sheet transport device is controlled to transport the actual sheet approximately synchronous to the movement of the (virtual) frame along the sheet transport path.

Upon entering the aligner 15, the lead edge of the sheet will be detected, as indicated by block 106. In decision block 108, it is determined whether the sheet 38 is in the desired position defined by the frame within predetermined limits. The predetermined limits define a predetermined maximum deviation from the desired sheet position defined by the frame in the in-track direction. The predetermined limits may be defined in accordance with the capability of the aligner 15 to speed-up/delay movement of a sheet there through for transferring the sheet to transport unit 28, without interfering with sheets in previous or subsequent frames.

If it is determined in block 108 that the sheet is positioned within predetermined limits with respect to its desired position (i.e. matches the frame position within predetermined limits), the process proceeds to block 110. In block 110 a fixed timer for issuing the start of frame signal is started, at a fixed predetermined time after generation of frame clock signal n in accordance with which the sheet was fed into the transport path 7. This is indicated in block 110 by the notation n+x, wherein n+x could signify the generation of a frame clock signal n+x in the series of frame clock signals, wherein x is an integer. Alternatively n could stand for the point in time when the frame clock signal n was generated and x could denote a specific time span.

The fixed timer after being started will issue a start of frame signal after a fixed time. The start of frame signal will then start generation of a latent toner image at print module 45, by first generating a latent charge image on the photoconductor drum 47 of the respective print module 45 followed by transferring the toner thereto according to the latent charge image. If more than one print module 45 is involved, a fixed timer for each print module (each setting a different predetermined time) for issuing respective start of frame signals may be started at the same time, as obviously the start of frame signals have to be staggered for the different print modules 45.

Starting generation of the latent toner image in accordance with the start of frame signal is indicated by block 112.

In accordance with block 114 the aligner 15 will then be controlled in such a manner that the in-track sheet position of the sheet is aligned in accordance with the start of frame signal. This alignment entails transferring the sheet from the aligner 15 to belt 30 of transport unit 28 at a fixed timing with respect to the start of frame signal. By so doing, it may be ensured that the sheet 38 enters the transfer nip between transfer roller 55 and back-up roller 57 of each print module in registration with the latent toner image. In accordance with block 116 the latent toner image is printed onto the sheet while being transported through the nip between transfer roller 55 and back-up roller 57, i.e. the latent toner image is transferred in the nip in a registered manner, to the sheet. The image is then fused to the sheet as is known in the art.

If it was determined in block 108 that the sheet does not match the desired in-track position as defined by the frame within predetermined limits, the process proceeds to block 118.

In block 118 a time shift Δt for starting the fixed timer for issuing the start of frame signal is determined. This time shift is determined in accordance with the deviation of the sheet from its desired position, i.e. the virtual frame position. The term Δt defines a time span, and may have a positive or negative value, depending of whether the sheet is to far advanced with respect to the frame position or to far behind.

In block 120 the fixed timer for issuing the start of frame signal is started, at a specified time after generation of frame clock signal n in accordance with which the sheet was fed into the transport path 7. This is indicated in block 120 by the notation n+x+Δt, wherein the term n+x may have the same meaning as explained above and wherein the term Δt corresponds to the time shift determined in block 118.

The fixed timer after being started will again issue a start of frame signal after a fixed time. The start of frame signal will then start generation of a latent toner image at print module 45, by first generating a latent charge image on the photoconductor drum 47 of the respective print module 45 followed by transferring the toner thereto according to the latent charge image. If more than one print module 45 is involved, a fixed timer for each print module (each setting a different predetermined time) for issuing respective start of frame signals may be started at the same time, as obviously the start of frame signals have to be staggered for the different print modules 45.

Starting generation of the latent toner image in accordance with the start of frame signal is indicated by block 122.

In accordance with block 124 the aligner 15 will then be controlled in such a manner that the in-track sheet position of the sheet is aligned in accordance with the start of frame signal. This alignment entails transferring the sheet from the aligner 15 to belt 30 of transport unit 28 at a fixed timing with respect to the start of frame signal. By so doing, it may be ensured that the sheet 38 enters the transfer nip between transfer roller 55 and back-up roller 57 of each print module in registration with the latent toner image. The process then proceeds to block 116 where the latent toner image is printed onto the sheet while being transported through the nip between transfer roller 55 and back-up roller 57, i.e. the latent toner image is transferred in the nip in a registered manner, to the sheet. The image is then fused to the sheet as is known in the art.

The above method of operating the printing apparatus thus uses a specific combination of the known paper-follows-image and image-follows-paper methods. This specific combination allows for a shorter transport unit for transporting the sheets through the print unit 17 compared to the transport unit required when using the image-follows-paper method. Furthermore there is no need of high accuracy transport mechanisms downstream of the aligner 15. If a sheet to be printed is fed to aligner 15 within predetermined limits, a paper-follows-image method may be used for the printing operation. If, however, a sheet arrives outside of the predetermined limits, the paper-follows-image operation would not be successful, as the sheet could not be supplied to the print module in proper timing due to speed-up/delay limits of the aligner 15. In this situation, the generation of the start of frame signal, respectively the start of a fixed timer for generating the start of frame signal has to be shifted in accordance with the image-follows-paper method of operation described above. Thereafter, however, a paper-follows-image method may again be used by aligning the in-track sheet position in accordance with the start of frame signal.

The invention was described with respect to an exemplary embodiment without being limited to this embodiment. The scope of the invention is defined by the appended claims.

1. A method of printing an image onto a sheet in a printer having at least one print module and a transport arrangement defining a transport path for transporting sheets past the at least one printing module, said method comprising the steps of:
generating a series of constant frame clock signals;
feeding a sheet approximately into a flame along the sheet transport path in accordance with the frame clock signal, wherein the frame defines a virtual desired sheet position, which moves with a predetermined speed along the sheet transport path;
transporting the sheet along the sheet transport path;
determining an in-track position of the sheet in the sheet transport path and determining whether the in-track sheet position matches the frame within predetermined limits;
if the sheet matches the frame within predetermined limits, issuing a start of frame signal at a predetermined fixed time following the generation of the frame clock signal in accordance with which the sheet was fed into the frame, wherein the start of frame signal starts generation of a latent toner image in the print module for transfer to the sheet;
if the sheet does not match the frame position within predetermined limits, issuing the start of frame signal at a specified time following the generation of the frame clock signal in accordance with which the sheet was fed into the frame, wherein the specified time corresponds to the predetermined fixed time to which a time shift is added, wherein the time shift is determined on the basis of the deviation of the actual sheet;
aligning the sheet in-track in accordance with the start of frame signal, and transporting the thus aligned sheet through the print module in alignment with the latent toner image to transfer the same to the sheet.

2. The method of claim 1, wherein the step of aligning the sheet in track at least partially overlaps in time with the generation of the latent toner image in the print module.

3. The method of claim 1, wherein the sheet is transported over several sheet lengths along the transport path between feeding the sheet and determining its in-track position.

4. The method of claim 1, wherein the sheet is fed into the frame position by a sheet feeder associated with a sheet supply storing a stack of sheets.

5. The method of claim 1, wherein the sheet is fed into the frame position by a speed up/delay unit associated with a duplex path of the printer.

6. The method of claim 1, wherein a print queue assigning an image to be printed to a frame is generated prior to feeding the sheet to the frame position.

7. The method of claim 1, wherein determination of the in-track position of the sheet is performed in an alignment unit, in which the sheet is aligned.

8. The method of claim 7, wherein the alignment unit comprises a pre-alignment unit and a final-alignment unit and wherein determination of the in-track position of the sheet for the purpose of determining whether the in-track position matches the frame within predetermined limits is performed at in the pre-alignment unit.

9. The method of claim 8, wherein determination of the in track position is performed at a downstream end of the pre-alignment unit.

10. The method of claim 1, wherein determination of the in-track position is performed by detecting a lead edge of the sheet in at least one position.

11. The method of claim 1, wherein determination of the in-track position of the sheet is performed by detecting a lead edge of the sheet in at least two positions, which are separated by a predetermined distance in a direction at right angles with respect to the direction of transport of the sheet.

12. The method of claim 1, wherein the predetermined limits are defined by the capacity of an alignment unit to speed up/delay transport of the sheet along the transport path within the alignment unit.

13. The method of claim 12, wherein the capacity of the alignment unit to speed up/delay transport of the sheet along the transport path is calculated on the basis of at least one of an x-track- and a skew-misalignment of the sheet upon entering the alignment unit.

14. The method of claim 1, wherein prior to or during the in-track alignment the sheet is also aligned with respect to skew and a cross-track position.

15. The method of claim 1, wherein alignment of the sheet is performed in an alignment unit, which transfers the sheet to a predetermined position onto a transport arrangement for transporting the sheet past the at least one print module.

16. The method of claim 15, wherein the transport arrangement is comprises a belt, which is frictionally coupled to a photoconductor drum of the print module.
